(19) United States
(12) Patent Application Publication
(10) Pub. No.: US 2013/0339532 A1
(43) Pub. Date: Dec. 19, 2013

(54) SYSTEM AND METHOD FOR COOKIE-BASED BROWSER IDENTIFICATION AND TRACKING

(71) Applicants: Richard Nelson, McLean, VA (US); Douglas Dillon, Gaithersburg, MD (US)

(72) Inventors: Richard Nelson, McLean, VA (US); Douglas Dillon, Gaithersburg, MD (US)

(21) Appl. No.: 13/526,275

(22) Filed: Jun. 18, 2012

(51) Int. Cl. G06F 15/16

(52) U.S. Cl. 709/228

(57) ABSTRACT

The present invention provides a system and method to identify unique browsers (Agents) communicating to the client. Every new browser communicating through the client is assigned a unique Agent ID that is stored in the browser's cookie cache. When the browser sends a request, the cookie may have the Agent ID to identify the browser to the client. If the cookie with the Agent ID is not present, then the client will return a re-direction response to a common URL with the domain having the cookie with the Agent ID to identify the unique browser. Another re-direction takes place back to the browser to make the request with the original URL, but this time has the cookie with the Agent ID to identify the unique browser.

### BACKGROUND

The present invention generally deals with http cookies, and their use to identify browsers.

A cookie, also known as an HTTP cookie, web cookie, or browser cookie, is used for an origin website to send state information to a user's browser and for the browser to return the state information to the origin site. The state information can be used for authentication, identification of a user session, user's preferences, shopping cart contents, or anything else that can be accomplished through storing text data.

Cookies are arbitrary pieces of data chosen by the web server and sent to the browser. The browser returns them unchanged to the server, introducing a state (memory of previous events) into otherwise stateless HTTP transactions. Without cookies, each retrieval of a Web page or component of a Web page is an isolated event, mostly unrelated to all other views of the pages of the same site. Other than being set by a web server, cookies can also be set by a script in a language such as JavaScript, if supported and enabled by the Web browser.

A conventional cookie-based communication system will now be described with reference to FIG. 1.

FIG. 1 illustrates a conventional communication system 100.

As shown in the figure, communication system 100 includes a user device 102, an Internet service provider (ISP) 104, the Internet 106 and a web server 108. User device 102 includes a browser 110 and a cookie cache 112.

In this example, each of browser 110 and cookie cache 112 are represented as distinct devices. However, in some situations browser 110 and cookie cache 112 may be a unitary device. Further, in some situations, at least one of browser 110 and cookie cache 112 may be contained as a utility, program, or subprogram, in any desired tangible computer readable storage medium. In addition, the operations may be embodied by computer programs, which can exist in a variety of forms both active and inactive. For example, they may exist as software program(s) comprised of program instructions in source code, object code, executable code or other formats. Any of the above may be embodied on a tangible computer readable storage medium, which include storage devices. Exemplary tangible computer readable storage media include conventional computer system RAM, ROM, EPROM, EEPROM, and magnetic or optical disks or tapes. Concrete examples of the foregoing include distribution of the programs on a CD ROM or via Internet download. It is therefore to be understood that any electronic device capable of executing the above-described functions may perform those functions enumerated above. When information is transferred or provided over a network or another communications connection (either hardwired, wireless, or a combination of hardwired and wireless) to a computer, the computer properly views the connection as a tangible computer-readable storage medium. Thus, any such connection is properly termed a tangible computer-readable storage medium. Combinations of the above should also be included within the scope of computer-readable storage media.

User device 102 is arranged to bi-directionally communicate with ISP 104 via a communication line 114. ISP is additionally arranged to bi-directionally communicate with Internet 106 via a communication line 116. Internet 106 is additionally arranged to bi-directionally communicate with web server 108 via a communication line 118.

Communication lines 114, 116 and 118 may be any known communication media. Signals within communication lines 114, 116 and 118 typically embody computer-readable instructions, data structures, program modules or other data in a modulated data signal such as a carrier wave or other transport mechanism and include any information-delivery media. Non-limiting examples of communications media of communication lines 114, 116 and 118 include wired media, such as wired networks and direct-wired connections, and wireless media such as acoustic, radio-frequency, infrared, etc.

In operation, take the example situation where user device 102 wants to visit a website, website.com, managed by web server 108. In such a case, browser 110 will send a request over communication line 114 to ISP 104 to connect with web server 108. At this point, ISP 104 will connect browser 110 to web server 108 by way of communication line 116, Internet 106 and communication line 118.

Web server 108 may want to create a cookie, identifying browser 110. As such, web server 108 will send cookie information back to user device 102, by way of communication line 118, Internet 106, communication line 116, ISP 104 and communication line 114. Upon receiving the cookie information, user device 102 may store the information in cookie cache 112.

Once the cookie information is stored in cookie cache 112, web server 108 will have access to the cookie information for any subsequent visit by user device 102. The cookie information may include additional information that will speed up loading time on subsequent visits from browser 110 to web server 108, for example by preloading data for authentication, identification of a user session, user's preferences, shopping cart contents, or anything else that can be accomplished through storing text data.

FIG. 2 illustrates a conventional satellite communication system 200.

As shown in the figure, communication system 200 includes user device 102, a very small aperture terminal (VSAT) 202, a satellite 204, an ISP 206, the Internet 106 and web server 108.

User device 102 is arranged to bi-directionally communicate with VSAT 202 via a communication line 210. VSAT 202 is additionally arranged to bi-directionally communicate with satellite 204 via a communication line 212. Satellite 204 is additionally arranged to bi-directionally communicate with ISP 206 via a communication line 214. ISP 206 is additionally arranged to bi-directionally communicate with internet 106 via communication line 116.

Communication line 210 may be any known communication media. Non-limiting examples of communications media of communication line 210 include wired media, such as wired networks and direct-wired connections, and wireless media such as acoustic, radio-frequency, infrared, etc. Signals within communication lines 210, 212 and 214 typically embody computer-readable instructions, data structures, program modules or other data in a modulated data signal such as a carrier wave or other transport mechanism and include any information-delivery media.

In operation, take the example situation where user device 102 wants to visit a website, website.com, managed by web server 108. In such a case, browser 110 will send a request, to connect with web server 108, over communication line 210 to VSAT 202. VSAT 202 will transmit the request to satellite 204, which will then transmit the request down to ISP 206. At this point, ISP 206 will forward the request to web server 108 by way of communication line 116, Internet 106 and communication line 118.

It should be noted that conventional satellite communication system 200 is used merely as a non-limiting example HTTP communication system. Any known communication system may be used wherein VSAT 202 may be replaced with any known intermediate device having the ability to edit browser initiated HTTP traffic may be used. Non-limiting examples of intermediate devices include a router, a firewall, a broadband modem, a wireless access point, and a HTTP proxy-server.

It should be noted that time to transmit the request from user device 102 to ISP 206, by way of communication line 210, VSAT 202, communication line 212, Satellite 204 and communication line 214, is dramatically longer than the time to transmit a request from user device 102 to ISP 104 of FIG. 1.

It should be noted that time to transmit the response from web server 108 to user device 102, by way of communication line 118, Internet 106, communication line 116, ISP 206, communication line 214, satellite 204, communication line 212, VSAT 202 and communication line 210, is dramatically longer than the time to transmit a response from web server 108 to user device 102 of FIG. 1.

To mitigate the transmission time in a satellite communication system, a clone browser may be used in the ISP. This will be described in detail with reference to FIG. 3.

FIG. 3 illustrates a conventional satellite communication system with clone browser, which emulates browser 110, as will be described in greater detail below.

As shown in the figure, communication system 300 is similar to communication system 200 of FIG. 2, where ISP 206 has been replaced with ISP 302. Further ISP 302 includes a clone browser 304.

To mitigate wait time in situations with satellite communication system 200, in communication system 300, clone browser 304 eliminates multiple passes through satellite 204. In particular, in the event there are multiple embedded objects in the web page, clone browser 304 performs the requests for the embedded objects with web server 108. Accordingly, the wait time for clone browser 304 (within ISP 302) to perform multiple requests with web server 108 in satellite communication system 300 is the same as the wait time for ISP 104 to perform multiple requests with web server 108 in communication system 100 of FIG. 1.

While clone browser 304 completes the multiple transactions with web server 108, clone browser 304 is sending the new responses to VSAT 202 by way of communication line 214, satellite 204 and communication line 212.

There are instances where many user devices may want to share a VSAT. However, such sharing will eliminate the ability to use a clone browser as discussed above with reference to FIG. 3. This will be described with reference to FIG. 4.

FIG. 4 illustrates a modified conventional satellite communication system 400.

As shown in the figure, satellite communication system 400 includes communication system 300, with the addition of a user device 402 and a user device 404. User device 402 includes a browser 406 and a cookie cache 408, whereas user device 404 includes a browser 410 and a cookie cache 412.

User device 402 is arranged to bi-directionally communicate with VSAT 202 via a communication line 414, whereas user device 404 is arranged to bi-directionally communicate with VSAT 202 via a communication line 416.

Communication lines 414 and 416 may be any known communication media. Non-limiting examples of communications media of communication lines 414 and 416 include wired media, such as wired networks and direct-wired connections; and wireless media such as acoustic, radio-frequency, infrared, etc. Signals within communication lines 414 and 416 typically embody computer-readable instructions, data structures, program modules or other data in a modulated data signal such as a carrier wave or other transport mechanism and include any information-delivery media.

A problem with satellite communication system 400 is that clone browser 304 now acts as a clone for the combination of browsers 110, 406 and 410. Clone browser 304 cannot make requests for browsers 110, 406 and 410 simultaneously. Therefore, clone browser 304 acting as an intermediary between web server 108 and any one of browsers 110, 406 and 410 may have limited web acceleration as only one browser request can be handled by the clone browser at a time. If more than one of browsers 110, 406, 410 make requests at the same time, the single clone browser 304 can only handle one for web acceleration.

What is needed is a system and method to differentiate the browsers on the remote VSAT side to be paired up with unique clone browsers on the ISP.

What is additionally needed is an ISP system and method that is able to track individual browsers. This capability is currently only available to web sites.

### BRIEF SUMMARY

The present invention provides a system and method that accelerate web pages between a browser and a web server and enables sharing of a VSAT in a satellite based communication system.

The present invention provides an ISP system and method that is able to track individual browsers and the content they retrieve.

In accordance with an aspect of the present invention, a system is provided for use with a user device and a first server. The user device has a browser therein. The browser can generate a first request to connect with the first server. The system includes a communication portion, a second server, a browser, a redirecting portion and a storage portion. The communication portion can receive the first request. The second server can generate a browser identifier that identifies the browser. The browser identifying portion can determine whether the first request includes the browser identifier. The redirecting portion can connect the browser to the second server when the browser identifying portion determines that the first request includes an unrecognized browser identifier. The storage portion can store the browser identifier. The second server can further create the browser identifier and an instruction having the browser identifier. The instruction can instruct the user device to send a second request, having the browser identifier, to connect to the first server. The communication portion can further send the instruction to the user device and can receive the second request. The browser identifying portion can further determine whether the second request includes the browser identifier. The redirecting portion can further connect the browser to the second server when the browser identifying portion determines that the second request includes the browser identifier. The second server can further generate a third request to connect the browser to the first server, wherein the third request includes the browser identifier.

Additional advantages and novel features of the invention are set forth in part in the description which follows, and in part will become apparent to those skilled in the art upon examination of the following or may be learned by practice of the invention. The advantages of the invention may be realized and attained by means of the instrumentalities and combinations particularly pointed out in the appended claims.

### BRIEF SUMMARY OF THE DRAWINGS

The accompanying drawings, which are incorporated in and form a part of the specification, illustrate an exemplary embodiment of the present invention and, together with the description, serve to explain the principles of the invention. In the drawings:

FIG. 1 illustrates a conventional communication system;

FIG. 2 illustrates a conventional satellite communication system;

FIG. 3 illustrates a modified satellite communication system to enhance web acceleration

FIG. 4 illustrates a modified conventional satellite communication system;

FIG. 5 illustrates an example satellite communication system in accordance with aspects of the present invention;

FIG. 6 illustrates an example VSAT in accordance with aspects of the present invention;

FIG. 7 illustrates an example method of identifying a browser in accordance with aspects of the present invention; and

FIG. 8 illustrates a ladder timing diagram of a portion of the method of FIG. 7, wherein a browser is attempting to visit web server via a VSAT in accordance with aspects of the present invention.

### DETAILED DESCRIPTION

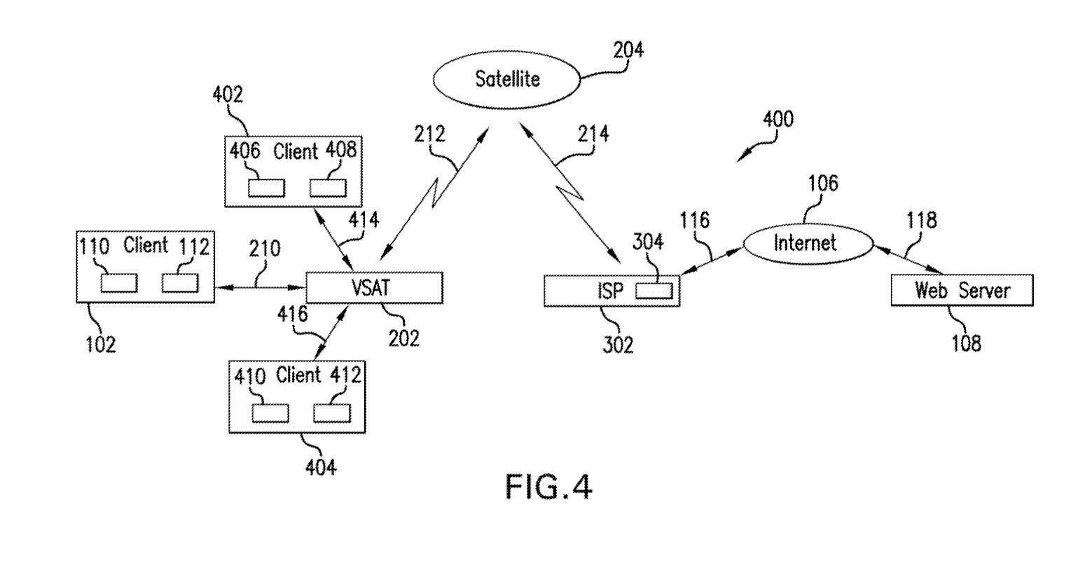

A satellite communication system in accordance with aspects of the present invention will now be described with reference to FIGS. 4-6.

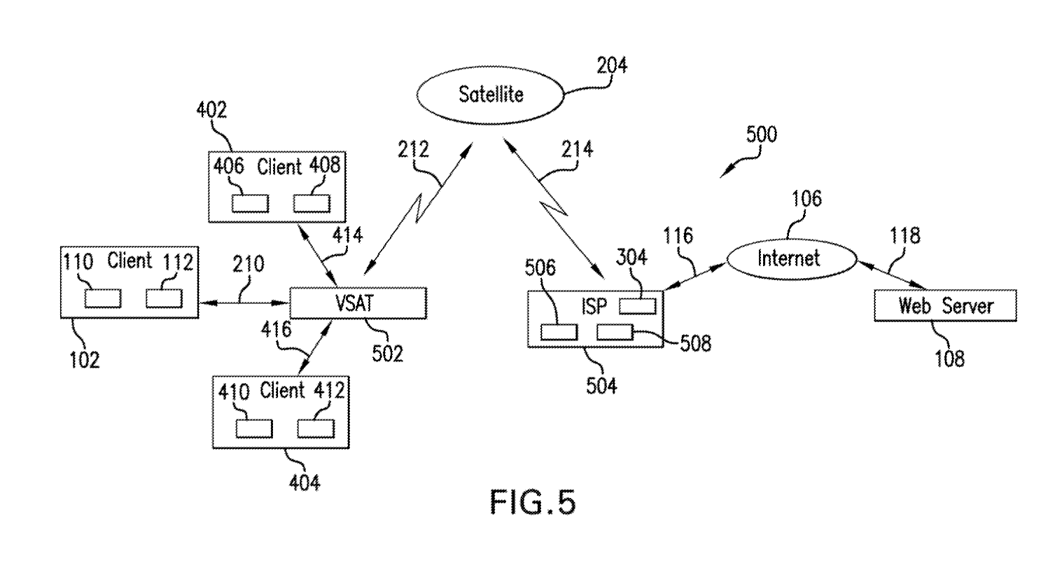

FIG. 5 illustrates an example satellite communication system 500, in accordance with aspects of the present invention.

As shown in the figure, communication system 500 includes user device 102, user device 402, user device 404, a VSAT 502, satellite 204, an ISP 504, the Internet 106 and web server 108. ISP 504 includes clone browser 304, a clone browser 506 and a clone browser 508.

User device 102 is arranged to bi-directionally communicate with VSAT 502 via communication line 210. User device 402 is arranged to bi-directionally communicate with VSAT 502 via communication line 414. User device 404 is arranged to bi-directionally communicate with VSAT 502 via communication line 416. VSAT 502 is additionally arranged to bi-directionally communicate with satellite 204 via communication line 212. Satellite 204 is additionally arranged to bi-directionally communicate with ISP 504 via a communication line 214. ISP 504 is additionally arranged to bi-dircctionally communicate with internet 106 via communication line 116.

In contrast with ISP 302 of satellite communication system 400, ISP 504 of satellite communication system 500 includes a distinct clone browser corresponding to each of browsers 110, 406 and 410. The clone browser behaves the same as the user device's browser. When an initial request is received from the user device's browser, the request is sent to the clone browser and the clone browser sends the request to the web server. The response is sent back to the clone browser prior to being sent to the user device's browser. The clone browser then makes all the requests for the embedded objects of the web page requested from the initial request and sends the responses to the VSAT. The VSAT holds the responses until requested by the user device's browser. This saves considerable amount of time as the requests for the embedded objects of the web page are not sent over the satellite link, but terminate at the VSAT where the responses are being held.

It should be noted that adding multiple clone browsers to ISP 504 is not a trivial matter. An association must be established between each of browsers 110, 406 and 410 and respective clone browsers 304, 506 and 508. Aspects of the present invention enable such an association. This will now be described in greater detail.

In operation, for purposes of discussion, presume that a user at user device 102 wants to visit a website managed by web server 108. In such a case, browser 110 will send a request to web server 108. In accordance with aspects of the present invention, when VSAT 502 receives the request from browser 110, the browser identification may be handled in one of three modes.

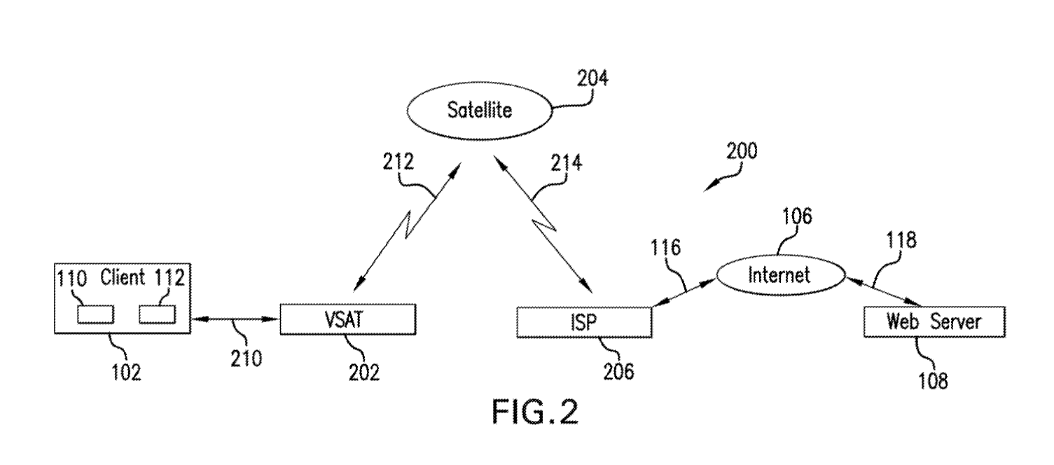

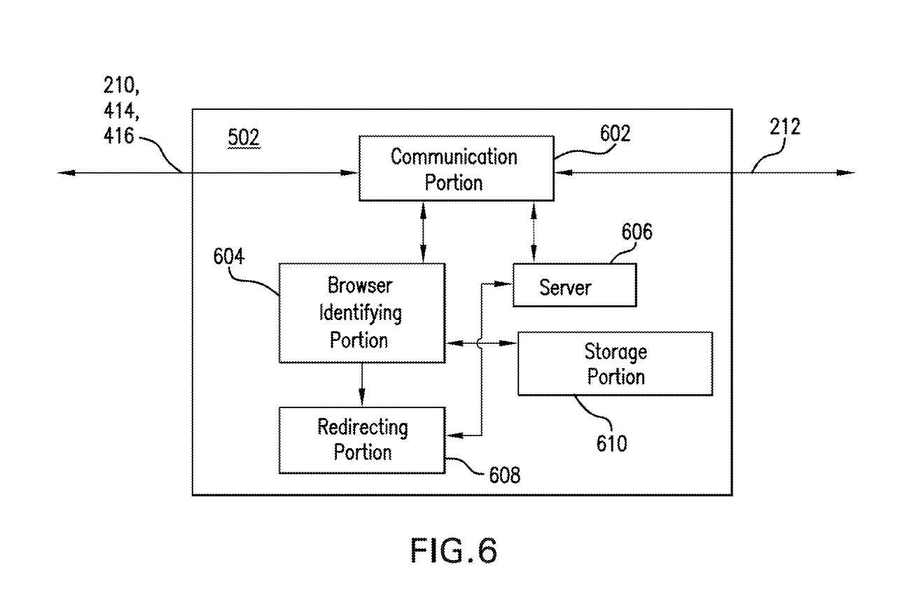

In the first mode, VSAT 502 may pass through the request to web server 108 and no web page acceleration is performed. In this mode, system 400 may ultimately result in an operation similar to system 200 discussed above with reference to FIG. 2. There are many reasons that may compel system 500 to perform in this manner, as will be described in greater detail below with reference to FIG. 6.

In the second mode, VSAT 502 may perform a series of actions in order to store cookie information related to browser-server pair in the browser's cookie cache. This mode establishes a respective and distinctive session between a single browser and a single clone browser. In this mode, VSAT 502 may redirect the request a number of times to recognize browser 110. The stored cookie information in the browser's cookie cache attained in the second mode may then be used in the third mode. This will be described in greater detail below with reference to FIG. 6.

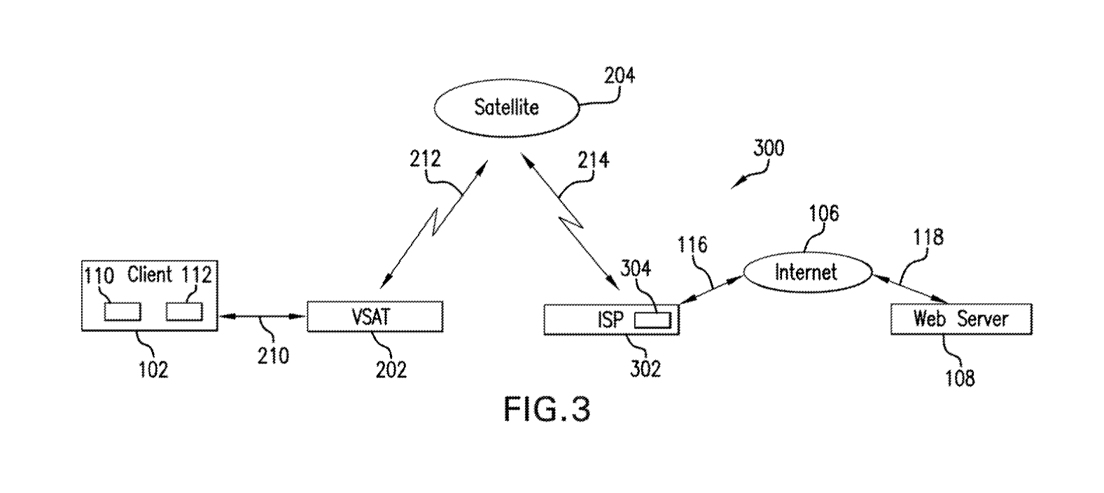

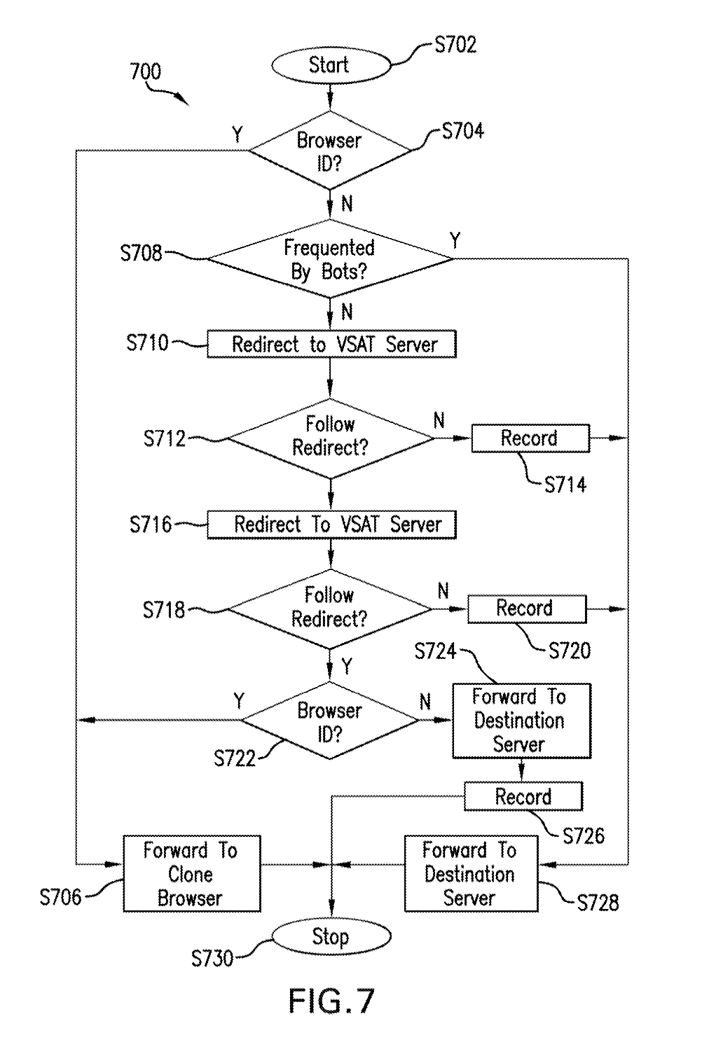

In the third mode, VSAT 502 may quickly identify browser 110 and know the corresponding clone browser in ISP 504, if VSAT 502 had previously stored the information in the second mode. This mode uses the established distinctive link between a single browser and a single clone browser. In this mode, system 500 results in an accelerated operation, similar to that of system 300 discussed above with reference to FIG. 3, but with a plurality of user devices sharing a single VSAT. In essence, browser 110 will not need to send all requests to web server 108 through satellite 204. On the contrary, VSAT 502 is able to quickly provide the responses to browser 110. This will be described in greater detail below with reference to FIG. 7.

VSAT 502 differs from VSAT 202 to enable functionality of the present invention.

FIG. 6 illustrates an example VSAT in accordance with aspects of the present invention.

As illustrated in the figure, VSAT 502 includes a communication portion 602, a browser identification portion 604, a server 606, a redirecting portion 608 and a storage portion 610. In this example, each of communication portion 602, browser identification portion 604, server 606, redirecting portion 608 and storage portion 610 are represented as distinct devices. However, in some situations, at least two of communication portion 602, browser identification portion 604, server 606, redirecting portion 608 and storage portion 610 may be a unitary device. Further, in some situations, at least one of communication portion 602, browser identification portion 604, server 606, redirecting portion 608 and storage portion 610 may be contained as a utility, program, or subprogram, in any desired tangible computer readable storage medium.

In this example embodiment, communication portion 602 is arranged to receive/transmit communications with communication lines 210, 414, 416 and 212, to communicate with browser identifying portion 604 and to bi-directionally communicate with server 606. Browser identifying portion 604 is additionally arranged to communicate with redirecting portion 608 and to bi-directionally communicate with storage portion 610. Redirecting portion 608 is additionally arranged to bi-directionally communicate with server 606.

Communication portion 602 may be any device or system that is operable to transmit and receive information. In particular, communication portion 602 is operable to receive a first request from browser 110 to connect with web server 108. Communication portion 602 is further operable to send a redirection instruction to user device 102 and to receive a second request from browser 110 based on the redirection instruction.

Typically, in accordance with http protocol, when a get request is received, an http 200 valid response is provided. An http header is followed by the body, which may be an image or any type of information for web server 108. In accordance with aspects of the present invention, when a get request is received, a response includes an http 302 message, indicating to browser 110 that web server 108 has temporarily moved to the server of VSAT 502.

Browser identifying portion 604 may be any device or system that is operable to determine whether the first request includes the browser identifier. Browser identifying portion 604 is further operable to determine whether the second request from browser 110 includes the browser identifier.

In a preferred embodiment, VSAT 502 may operate as a transparent HTTP proxy and thus be able to edit the HTTP transactions—requests and responses. Any known system and method may be employed by VSAT 502 for editing the data coming from browser 110, even though it is being carried by the TCP protocol.

Server 606 may be any system or device that is operable to generate a browser identifier that identifies browser 110. Server 606 is further operable to create the browser identifier and to create an instruction having the browser identifier. The instruction can instruct user device 102 to send the second request, having the browser identifier, to connect to server 606. Server 606 is further operable to generate a third request to connect browser 110 to web server 108, wherein the third request includes the browser identifier.

Redirecting portion 608 may be any system or device that is operable to connect browser 110 to server 606 when browser identifying portion 604 determines that the first request includes an unrecognized browser identifier. Redirecting portion 608 is further operable to connect browser 110 to server 108 when browser identifying portion 604 determines that the second request includes the browser identifier.

Storage portion 610 may be any system or device that is operable to store information, such as User-Agent information to identify robot browsers making requests that cannot be accelerated.

In accordance with aspects of the present invention, in a satellite communication system, wherein a browser wishes to connect a user device to a web server (for example as illustrated in FIG. 5), a browser's cookie cache stores a browser identifier-web server pair. After initial visit to web site, all future requests will have the browser identifier as part of the cookie cache and eliminates the need for the VSAT to re-direct to identify the browser. This will be described in greater detail with additional reference to FIG. 7.

An example method of operation of system 500 will now be described with reference to FIG. 7.

FIG. 7 illustrates an example method 700 of identifying a browser in accordance with aspects of the present invention.

Method 700 starts when a browser requests to connect with a web server (S702). For purposes of discussion, take the example wherein, as illustrated in FIG. 5, user device 102 desires to connect to web server 108.

Browser 110 sends an initial request to VSAT 502, via communication line 210, to connect to web server 108.

VSAT 502 must be able to recognize the browser making the request in order to match the browser with the corresponding clone browser in ISP 504.

Therefore, it is then determined whether the request includes a browser identifier (S704). This action takes place in VSAT 502. For example, as illustrated in FIG. 6, communication portion 602 receives the initial request from browser 110 via communication line 210. Communication portion 602 passes the initial request to browser identifying portion 604. At this point, browser identifying portion 604 determines whether the initial request includes a browser identifier cookie.

If browser 110 has previously requested a visit to web server 108, via VSAT 502, then the request may have a browser identifier. If the request has a browser identifier, then the browser making the request must have visited the web server before through VSAT 502. Accordingly, browser identifying portion allows VSAT 502 to pair the browser 110 to the corresponding clone browser 304. The initial request is then forwarded to paired clone browser 304 which will forward request to web server 108 (S706).

In this situation, returning to FIG. 5, the requesting browser may quickly receive the response related to the web page directly from VSAT 502 if the request is for an embedded object of the web page, as opposed to waiting for the request to travel through satellite 204 to web server 108 and then back from web server 108 and through satellite 204.

Returning to FIG. 7, the request may have an unrecognizable browser identifier (No in S704). VSAT 502 may search the HTTP header field to locate the browser identifier in the cookie field. For example, if browser 110 has not previously requested a visit to web server 108, via VSAT 502, then the request will not have a browser identifier—thus will be unrecognizable. Again, in this example, the request is an initial request for browser 110 to connect to web server 108 for the first time. In such situation, there will be no browser identifier. If the request does not have a browser identifier (or has an unrecognizable browser identifier), it is then determined whether the destination server is one frequented by HTTP robots that masquerade as a support browser or the browser type cannot support web acceleration because cookie cache is disabled or re-direction is not supported (S708). A list of such destination servers and browser types may be stored in storage portion 610.

In this situation, returning to FIG. 5, VSAT 502 may pass the initial request directly to web server 108, by passing any clone browser (S728). In this mode, system 500 may ultimately result in an operation similar to system 200 discussed above with reference to FIG. 2, with the exception that multiple user devices share a single VSAT. In essence, browser 110, (in this case a HTTP robot masquerading as a support browser, as will be discussed in greater detail later) will need to wait for the response to be retrieved from web server 108.

Returning to FIG. 7, if the request is not from HTTP robots that masquerade as a support browser (N in S708), then the initial request is forwarded to the VSAT server (S710). For example, returning to FIG. 6, redirecting portion 608 redirects the initial request back to browser 110 with the new location being server 606.

At this point, the initial request did not have a recognizable browser identifier (N in S704) and it has been determined that the destination server is not one that is frequented by bots (N in S708). Accordingly, VSAT 502 needs to recognize the requesting browser; in this case, browser 110. Server 606 will assign a browser identifier to the requesting browser. This is why redirecting portion 608 redirects the initial request back to browser 110 with a new browser identifier as the set-cookie field. This is the beginning of the second mode of operation of VSAT 502.

It is then determined whether the next request from browser 110 follows after receiving the redirection (S712). For example, server 606 should receive the next request sent from browser 110 after receiving the re-direct response telling the browser 110 to send the request to server 606.

If browser 110 does not follow the redirection, then browser 110 is masquerading as a supported browser and does not honor redirects. In such a case, the destination domain and browser type is recorded in the storage portion 610 and no further redirects are attempted for a predetermined period (S714).

If the initial request does not follow the redirect, the browser type and destination domain is recorded (S714). For example, browser identifying portion 604 lists browser 110 as a supported browser that does not honor redirects in storage portion 610. In future instances where browser 110 requests to connect to web server 108, (at S708) VSAT 502 will recognize browser 110 as a bot.

The request would then forwarded to the destination server (S728), bypassing the web acceleration.

In this situation, returning to FIG. 5, VSAT 502 may pass the initial request through to web server 108. In this mode, system 500 may ultimately result in an operation similar to system 200 discussed above with reference to FIG. 2.

If browser 110 follows the redirection (Yes at S712), it is then determined whether the redirected request includes a browser identifier. For example, when redirected to server 606 (at S710), server 606 should have added a browser identifier to the request. If the browser identifier is still not there, then the likely cause is one of: 1) browser 110 has recently cleared its cookies; 2) browser 110 has disabled its cookies; 3) the requestor is not a browser, but rather another agent masquerading as a supported browser; or 4) browser 110 is connecting to VSAT 502 for the first time.

If the redirected request does not include a browser identifier at this point, then the redirected request is redirected back to the destination server (S728). In an example embodiment, the redirected request is redirected back to the destination server with the same assigned browser identifier as discussed with reference to S710 as the set-cookie field. At this point, redirecting portion again redirects the redirected request from (the previously redirected address to) server 606 to (the originally requested address to) web server 108.

Returning to FIG. 7, if browser 110 follows the redirection (Yes at S712), the redirected request is again redirected to the original web server (S716). For example returning to FIG. 6, redirecting portion 608 redirects the request to (the originally requested address to) web server 108.

It is then determined whether the redirected request follows the second redirection (S718). For example, communication portion 602 should receive the twice-redirected request forwarded from redirecting portion 608 and pass to browser identifying portion 604.

If the redirected request does not follow the second redirection, then for some reason, browser 110 followed the first redirection (S712) but not the next (S718). In such an unusual case, the destination domain and browser type is recorded and no further redirects are attempted for a predetermined period (S720), a non-limiting example of a predetermined period includes 24 hours.

For example, browser identifying portion 604 lists browser 110 in storage portion 610 as an unusual situation browser that honored a first redirect but not a second redirect. In future instances within the predetermined period where browser 110 requests to connect to web server 108, (at S708) VSAT 502 will recognize browser 110 as a bot.

The request would then be forwarded to the destination server (S728), bypassing web acceleration.

In this situation, returning to FIG. 5, VSAT 502 may ultimately pass the initial request through to web server 108. In this mode, system 500 may ultimately result in an operation similar to system 200 discussed above with reference to FIG. 2. In essence, browser 110, (in this case a HTTP robot masquerading as a support browser) sends a request to web server 108 and ISP 504 passes the request directly to web server 108, bypassing web acceleration. As compared with the other situation where browser has the non-redirecting request (S714), in this situation, the automatic pass through will only last for the predetermined period, e.g., 24 hours. After the predetermined period expires, the browser is removed from storage portion, and again may have an opportunity for web page acceleration in accordance with the third mode of operation.

Returning to FIG. 7, if browser 110 follows the second redirection (Yes at S718), it is then determined whether the twice-redirected request includes a browser identifier (S722). For example, when redirected to server 606 (at S710), server 606 should have added a browser identifier to the request.

If the request does not include a browser identifier, then the twice-redirected request is forwarded to the destination server (S724). If the twice-redirected request does not include the browser identifier, then browser 110 has cookies disabled. If browser 110 has cookies disabled, then there is little reason to attempt to obtain/provide browser ID from cookie information from/to browser 110. As such, the twice-redirected request is then forwarded to web server 108.

At this point, the browser type and destination domain is recorded (S726). For example, browser identifying portion 604 lists browser 110 in storage portion 610 as a browser that has disabled cookies. In future instances where browser 110 requests to connect to web server 108, (at S708) VSAT 502 will recognize browser 110 as a browser that has disabled cookies.

In this situation, returning to FIG. 5, VSAT 502 may ultimately pass the initial request through to web server 108. In this mode, system 500 may ultimately result in an operation similar to system 200 discussed above with reference to FIG. 2.

Returning to FIG. 7, if the twice-redirected request includes a browser identifier (S718), then the twice-redirected request is then forwarded to paired clone browser 304 which will forward request to web server 108 (S706).

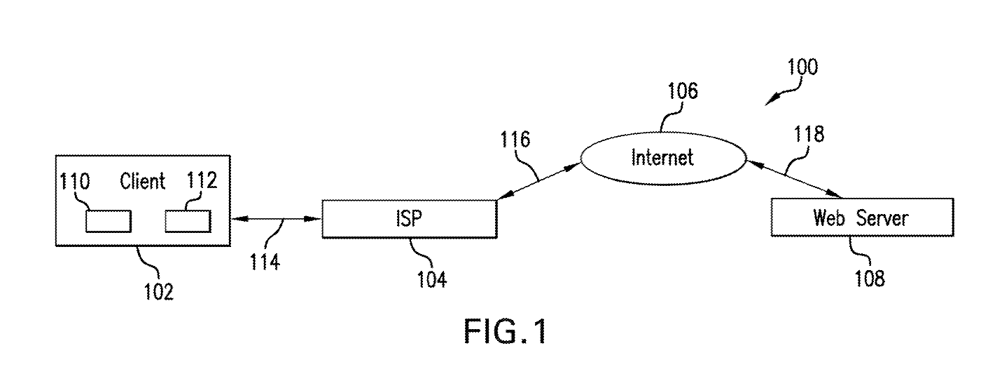

Aspects of the present invention may be used in systems that do not use a clone browser. For example, returning to FIG. 1, in accordance with aspects of the present invention, ISP 104 may be modified in a manner similar to VSAT 502, wherein the redirecting method of FIG. 7 is performed. In such a case, wherein there is no clone browser, the request will be forwarded directly to web server 108.

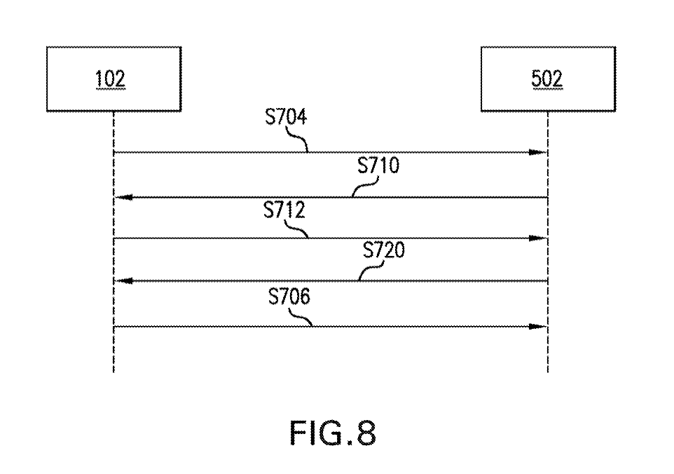

Method 700 then stops (S730). A more visual explanation of an example operation of a portion of method 700 will now be described with reference to FIG. 8.

FIG. 8 illustrates a ladder timing diagram of a portion of method 700, wherein browser 100 is attempting to visit web server 108 via VSAT 502.

As illustrated in the figure, in this example, a request is sent from browser 102 to VSAT 502. VSAT 502 determines that the request does not have a browser ID (S704). Then, VSAT 502 redirects the request to the VSAT server (S710). In this example, browser 102 follows the redirect and is assigned a browser ID (S712). At this point VSAT 502 recognizes the browser ID and instructs browser 102 to redirect the request to the destination server (S716). Finally, the request from browser 102 is redirected to the clone browser 304 by way of VSAT 502 (S706).

In this situation, returning to FIG. 5, VSAT 502 operates in the third mode. In this mode, system 500 result in an accelerated operation as compared to system 200 discussed above with reference to FIG. 3. In essence, browser 110 will not need to wait for responses from web server 108 through satellite 204 after sending requests to VSAT 502. On the contrary, VSAT 502 is able to quickly provide the responses to browser 110 since the responses had already been pre-fetched by clone browser 304.

The present invention provides a system and method for accelerating web pages. It should be noted that the non-limiting example embodiments discussed above having a satellite communication system are for illustrative purposes only. Any communication system that shares multiple user devices with a single ISP may benefit from aspects of the present invention.

The foregoing description of various preferred embodiments of the invention have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed as new and desired to be protected by Letters Patent of the United States is:

1. A system for use with a user device and a first server, the user device having a browser therein, the browser being operable to generate a first request to connect with the first server, said system comprising:
a communication portion operable to receive the first request;
a second server operable to generate a browser identifier that identifies the browser;
a browser identifying portion operable to determine whether the first request includes the browser identifier;
a redirecting portion operable to connect the browser to said second server when said browser identifying portion determines that the first request includes an unrecognized browser identifier; and
a storage portion operable to store the browser identifier,
wherein said second server is further operable to create the browser identifier and an instruction having the browser identifier, the instruction being operable to instruct the user device to send a second request, having the browser identifier, to connect to the first server,
wherein said communication portion is further operable to send the instruction to the user device and to receive the second request,
wherein said browser identifying portion is further operable to determine whether the second request includes the browser identifier,
wherein said redirecting portion is further operable to connect the browser to said second server when said browser identifying portion determines that the second request includes the browser identifier, and
wherein said second server is further operable to generate a third request to connect the browser to the first server, the third request including the browser identifier.

2. The system of claim 1, wherein said communication portion, said second server, said browser identifying portion, said redirecting portion and said storage portion form a portion of a very small aperture terminal.

3. The system of claim 2, wherein said communication portion is further operable to bi-directionally communicate with the first server.

4. The system of claim 3, wherein said communication portion follows http protocol.

5. The system of claim 1, wherein said communication portion is further operable to bi-directionally communicate with the first server.

6. The system of claim 5, wherein said communication portion follows http protocol.

7. The system of claim 1, wherein said communication portion follows http protocol.

8. A method of using a user device and a first server, the user device having a browser therein, the browser being operable to generate a first request to connect with the first server, said method comprising:
receiving, via a communication portion, the first request;
generating, via a second server, a browser identifier that identifies the browser;
determining, via a browser identifying portion, whether the first request includes the browser identifier;
connecting, via a redirecting portion, the browser to the second server when the browser identifying portion determines that the first request includes an unrecognized browser identifier;
storing, via a storage portion, store the browser identifier;
creating, via the second server, the browser identifier and an instruction having the browser identifier, the instruction being operable to instruct the user device to send a second request, having the browser identifier, to connect to the first server;
sending, via the communication portion, the instruction to the user device;
receiving, via the communication portion, the second request;
determining, via the browser identifying portion, whether the second request includes the browser identifier;
connecting, via the redirecting portion, the browser to the second server when the browser identifying portion determines that the second request includes the browser identifier; and
generating, via the second server, a third request to connect the browser to the first server, the third request including the browser identifier.

9. The method of claim 8, further comprising bi-directionally communicating, via the communication portion, with the first server.

10. The method of claim 9, wherein said receiving, via a communication portion, the first request comprises receiving the first request in accordance with http protocol.

11. The method of claim 8, wherein said receiving, via a communication portion, the first request comprises receiving the first request in accordance with http protocol.

12. A tangible computer-readable media having computer-readable instructions stored thereon, the computer-readable instructions being capable of being read by a computer to be used with a user device and a first server, the user device having a browser therein, the browser being operable to generate a first request to connect with the first server, the tangible computer-readable instructions being capable of instructing the computer to perform the method comprising:
receiving, via a communication portion, the first request;
generating, via a second server, a browser identifier that identifies the browser;
determining, via a browser identifying portion, whether the first request includes the browser identifier;
connecting, via a redirecting portion, the browser to the second server when the browser identifying portion determines that the first request includes an unrecognized browser identifier;
storing, via a storage portion, the browser identifier;
creating, via the second server, the browser identifier and an instruction having the browser identifier, the instruction being operable to instruct the user device to send a second request, having the browser identifier, to connect to the first server;
sending, via the communication portion, the instruction to the user device;
receiving, via the communication portion, the second request;
determining, via the browser identifying portion, whether the second request includes the browser identifier;
connecting, via the redirecting portion, the browser to the second server when the browser identifying portion determines that the second request includes the browser identifier; and
generating, via the second server, a third request to connect the browser to the first server, the third request including the browser identifier.

13. The tangible computer-readable media of claim 12, the computer-readable instructions being capable of instructing the computer to perform said method further comprising bi-directionally communicating, via the communication portion, with the first server.

14. The tangible computer-readable media of claim 13, the computer-readable instructions being capable of instructing the computer to perform said method wherein said receiving, via a communication portion, the first request comprises receiving the first request in accordance with http protocol.

15. The tangible computer-readable media of claim 12, the computer-readable instructions being capable of instructing the computer to perform said method wherein said receiving, via a communication portion, the first request comprises receiving the first request in accordance with http protocol.
